(19) United States
(12) Patent Application Publication
(10) Pub. No.: US 2007/0123251 A1
(43) Pub. Date: May 31, 2007

(54) Remote internet telephony device

(75) Inventor: David McElvaney, (US)

Correspondence Address: Max Stul Oppenheimer, P.O. Box 50, Stevenson, MD, 21153, US

(73) Assignee: Riparius Ventures, LLC

(21) Appl. No.: 11/518,756

(22) Filed: Sep. 11, 2006

Related U.S. Application Data
(63) Continuation-in-part of application No. 11/299,439, filed on Dec. 13, 2005, now Pat. No. 7,139,371.
Application No. 11/299,439 is a continuation of application No. 09/734,163, filed on Dec. 11, 2000, now Pat. No. 7,016,481.
Application No. 09/734,163 is a continuation-in-part of application No. 08/734,857, filed on Oct. 23, 1996, now Pat. No. 6,859,525.

(51) Int. Cl. H04Q 7/20

(52) U.S. Cl. 455/426.1

(57) ABSTRACT

Remote receipt and placement of Internet Telephony communications emulates traditional POTS telephone service through a combination of software and a specialized cordless telephony device, allowing ringing and answering of inbound calls, dialing of outbound numbers, and signaling of handset status, as well as traditional telephony capabilities such as memory dialing, redial and radio channel controls. Voice control of dialing may also be implemented under software control. This system is easily adapted for operation with most PC based Internet Telephony software systems. This system may be combined with a regular POTS cordless telephone which allows for standard POTS calls and contacting emergency services.

This application is a continuation-in-part of U.S. application Ser. No. 11/299,439 (filed Dec. 13, 2005), which is a continuation of U.S. application Ser. No. 09/734,163 (filed Dec. 11, 2000), now U.S. Pat. No. 7,016,481 (issued Mar. 21, 2006), which is a continuation-in-part of U.S. application Ser. No. 08/734,857 (filed Oct. 23, 1996), now U.S. Pat. No. 6,859,525 (issued Feb. 22, 2005).

### FIELD AND BACKGROUND OF THE INVENTION

1. Field of the Invention

The present invention relates to the field of Internet Telephony, and in particular, the emulation of POTS call placement and receipt using a specialized cordless telephony device.

2. Background Information

The recent surge in Internet Telephony software and infrastructure creation has provided the public with the ability to make and receive voice calls from a PC to other PC's and telephones. In the year 2000 systems such as the TRIDENT (tm) system developed by Pagoo, and DIALPAD (tm) provided this capability. More recently, SKYPE (tm), VOIPBUSTER (tm), and some Instant Messenger applications allow inbound and outbound calling between a telephone and a PC, many similar services are expected to appear in the near future from other Internet Telephony Service Providers.

Prior art relies on audio ringing via speakers or other sound card/DSP (Digital Signal Processor) based devices to play a ringing sound that notifies the user of an inbound call. This has created the situation where even with volume set high, a user is required to stay within audio range of their computer to receive a call, and then quickly reduce the volume as the call is accepted, or alternatively, stay in front of the computer at any time a call is expected. There is no way to remotely answer an inbound call, or dial without replacing the entire PC sound system with a custom device. Even such custom devices attempt to interface a standard two wire telephone, creating the problem of echo, which most DSP based processing cannot fully eliminate. Additionally, operating a PC with multiple sound devices such as a Voice modem, Sound Card, and telephone adapter can cause massive user confusion as PC standard audio must be mapped to the proper device for each use. The best example is the standard WAV file, which may be music, game sound effects, a Windows alert sound, Internet Telephony Voice or an Internet Telephony “Ring”. Mapping of a WAV file to the correct device and maintaining those mappings is usually beyond an average user's capability, and automated mapping often has unintended and undesirable results. USB (Universal Serial Bus) based corded solutions which also add an additional sound system suffer from some of the same issues, and are additionally limited by the USB specification to approximately 12 ft. range from the computer.

### SUMMARY OF THE INVENTION

Remote Cordless Internet Telephony is enabled with a specialized cordless telephone, providing the means to signal device ready status, trigger a standard telephone ring, and transport audio, control and DTMF tones or keystroke data to a standard PC sound card and/or I/O port. In one embodiment, a connection is made to a standard RS232 port available on most personal computers for the ring and status signal, as well as an audio connection to the microphone and speaker outputs of a pc's existing sound card. In other embodiments, USB ports or FIREWIRE (TM) or other connection means may be used which enables a more robust data communication path to the cordless telephony device. The cordless telephony device is accompanied by software that provides for detecting the presence of the telephone on any port, providing ready status where “ready” is defined as either (1) on hook in base or (2) out of base, not in use with radios and security codes synchronized or (3) capable of receiving or initiating a call. The software provides an interface to standard Internet Telephony systems in the simplest possible terms which may be characterized as “Unit Ready” and “Ring Unit”. The audio portion of the device operates independently, and may be used under manual control or disabled by program control if desired. The combined hardware and software portions allow Internet Telephony applications to sense off hook, issue a dial tone, receive DTMF tones or other keystroke data, respond with data or audiovisual prompts, and provide audible remote ring for an outbound call, as well as ring and connect inbound calls and other typical call progress indications. This allows full emulation of the POTS line user experience. The combined hardware and software deliver and receive digitized audio and data to/from the Internet by means of a high speed direct connection to the Internet. The connection may consist of, but is not limited to, a broadband cable connection, a DSL connection, a wireless broadband connection, an Ethernet LAN connection, a fiber optic cable connection, metropolitan area WAN services, and short range wireless LAN connections.

Additionally, the remote handset, may be used to trigger events and programs via DTMF tones, keystroke data, or voice commands. Further embodiments of the invention may include Firewire port signaling, on-board DTMF decode, on-board voice control capabilities, remote display, and a full IP telephony support processing engine integrated with the base unit.

It is an object of the invention to provide a device and method for remote cordless internet telephony.

It is a further object of the invention to provide a device and method for communication over a digital network wherein a handset may be located more than 12 feet from the point of access to the digital network.

It is a further object of the invention to provide a device and method for communication over a digital network wherein a handset may be located more than 400 feet from the point of access to the digital network.

It is a further object of the invention to provide a device that facilitates both Cordless Internet Telephony phone calls and Cordless POTS phone calls.

### BRIEF DESCRIPTION OF THE DRAWINGS

The foregoing and still other objects of this invention will become apparent, along with various advantages and features of novelty residing in the present embodiments, from study of the following drawings, in which:

FIG. 1 is an overview block diagram of the specialized Cordless Internet Telephone device.

FIG. 2 is a flow chart of the software used to control hardware to emulate POTS line operation with an Internet Telephone call.

FIG. 3 is a connection diagram and block diagram of one preferred USB embodiment of the invention.

FIG. 4 is a block diagram of one embodiment of the invention.

FIG. 5 is a graphical user interface window typical of an Internet telephony application driver or direct interface.

FIG. 6 is a high level software functional diagram which illustrates the inter-operation of the software components of the invention.

### DESCRIPTION OF THE PREFERRED EMBODIMENT

The term “software” will generally be used as an adjective (for example: a software event) or as a superset of the term Program which will refer to some subset of all software involved) The term “POTS” refers to what is known in the art as a Plain Old Telephone System. The term “dialing” is used to include any method of selecting from among available options and is not limited to using a traditional rotary dial. For example, pressing a physical key, touching a virtual keyboard or issuing a voice command would be included, as would any other action equivalent in effect to dialing a POTS phone. In the following description of the preferred embodiment, references are made to the accompanying drawings. It is to be understood that other embodiments may be utilized and that other structural, logical and electrical changes may be made without departing from the scope of the present invention. This is to specifically include changes in packaging such as having a USB cable or providing for direct plug in, building the base unit electronics into a PC enclosure, or a plug in card/USB dongle or into a monitor or other display device, and the choice as to how to provide battery power and charging functions. Other embodiments may also include various combinations wherein functions described herein as Base functions may in fact be located in the Device Interface Program or other software and combined with a simplified USB dongle or key containing the radio frequency-section. Likewise functionality described as part of the Device Interface Program could be migrated to a more capable processor in the Base without departing from the scope of the present invention. Advancements in available telephony electronics and standards since the original application filing date have made several modifications to the original preferred embodiment desirable, for example:
The preferred embodiment now describes the use of the previously disclosed optional USB interface.
As USB ports are all digital, the audio and status information are combined on the same cable, but separated internally by the USB support functions in the operating system.
900 mhz has been replaced by higher frequencies for the RF communications.
DTMF and other keypress data is transmitted digitally on a USB interface.
The DECT (Digital Enhanced Cordless Telecommunications) standard published by the
European Telecommunications Standards Institute has become a preferred platform for cordless phone design.
Audio (tones, voice and other sounds) was previously transferred as an analog signal, but is now often transferred between components as data, for example, a PCM (Pulse Code Modulation) data stream. The term audio information used herein includes such encoded audio regardless of the chosen sampling or compression method.
Handset and base control chips are now capable of supporting multiple handsets and on-chip processing capability may be programmed for direct communication with a USB control chip as well as additional user defined functions including display support.

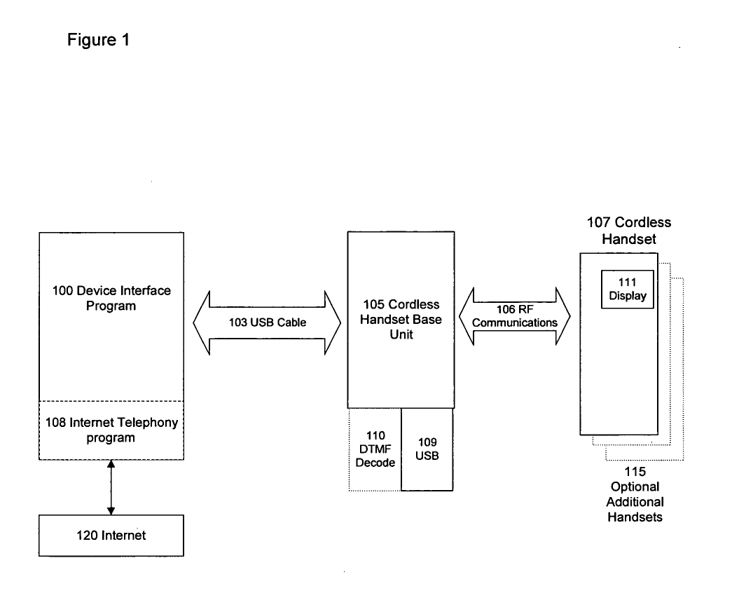

In FIG. 1 an overview of a remote Internet Telephony device is shown generally, which in the current preferred embodiment consists of a Device Interface Program 100, Base Unit 105 and Cordless Handset 107. In one embodiment the Base Unit 105 and Cordless handset 107 communicate using standard 2.4 ghz radios with multichannel capability, security codes and selection circuitry for multiple handset support (for example, as provided by the National Semiconductor/Sitel SC14430 and SC14428 series cordless phone control chips). Other embodiments may use different telephony chip sets or radio modules as such devices evolve, providing additional features and capabilities. In non-programmed operation the USB audio 440 may be always active, and capable of relaying the input/output of the Device Interface Program 100 sound system to the Base Unit 105, and if activated, the Cordless handset 107. Under program control, the Device Interface Program 100 additionally monitors the USB status and data 441 on USB Cable 103 and can receive and transmit ring and call status data as required by the Internet Telephony Program 108. USB audio 440 and USB status and data 441 are carried on the single USB Cable 103, but recognized by most operating systems as distinct devices.

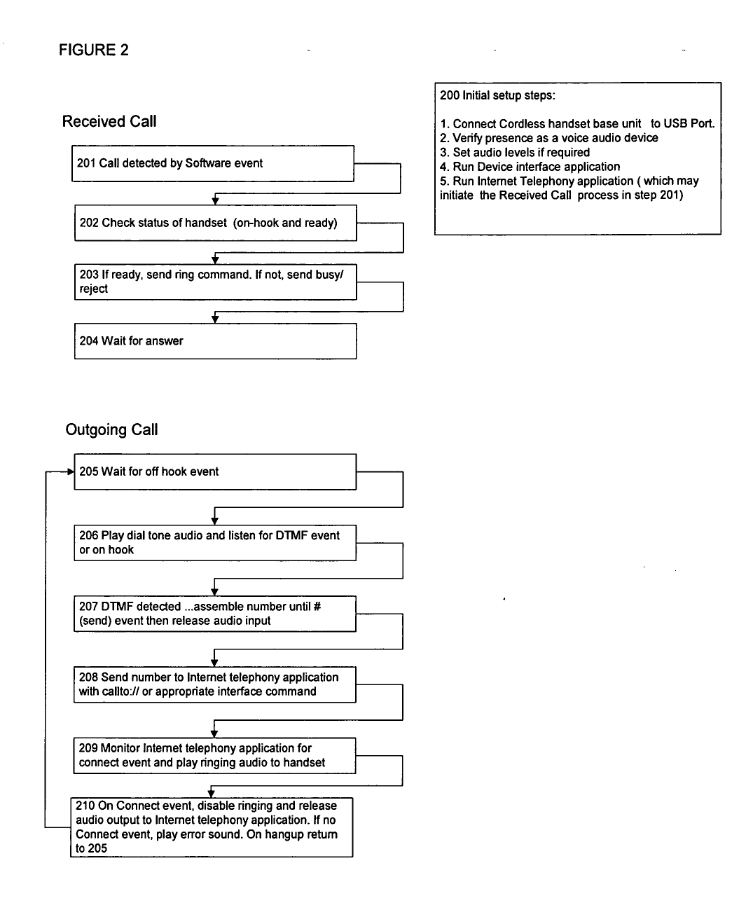

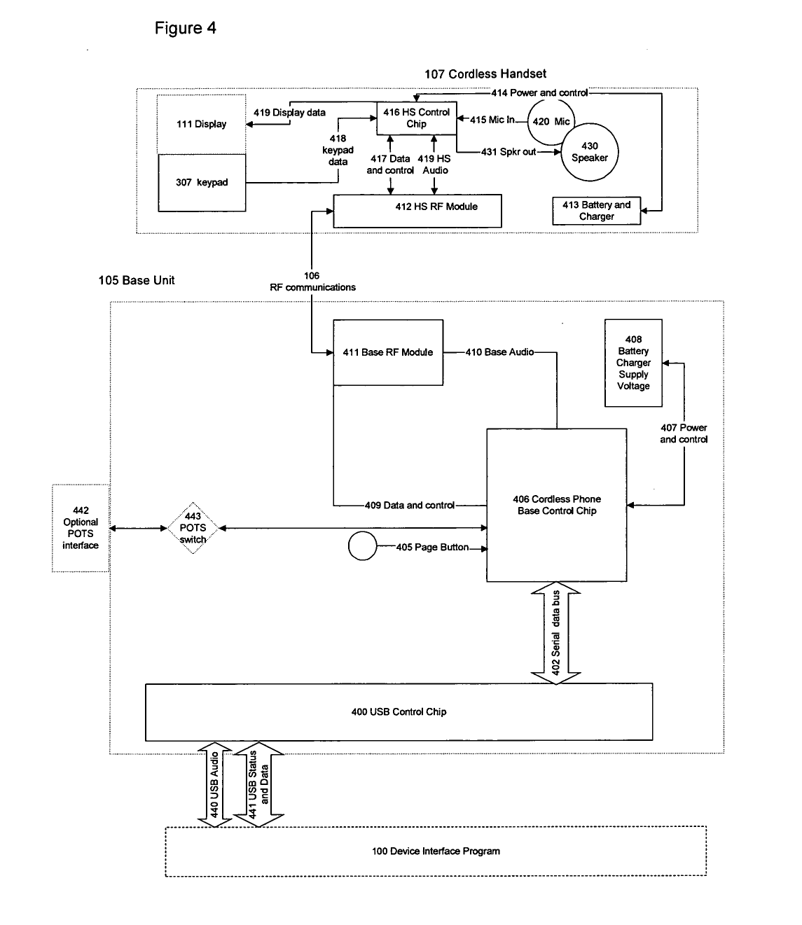

In FIG. 2 the progress of the software to emulate a POTS call is depicted using the hardware described in FIGS. 1 and 4. Initial Setup 200 shows the manual setup required by a user to establish an operable configuration. Detection of a call by the Internet Telephony Program 108 for example, Microsoft NetMeeting (tm), DLALPAD (tm), PAGOO (tm), ITXC WEBTALK NOW (tm), Avaya SOFTPHONE (tm), Microsoft Instant Messenger(TM), Net2Phone(TM), SKYPE (TM), VOIPBUSTER (tm) or other software based on VOIP (Voice over Internet Protocol) technology begins execution of the Device Interface Program 100 in step 201. The Device Interface Program 100 verifies the status of handset 202, and following the logic in 203, either rings or rejects the incoming call. Since some Internet Telephony programs allow multiple calls, the Device Interface Program 100 may optionally be configured to accept an additional inbound event, even if currently in use. If the incoming call software event ceases to be true, The Device Interface Program returns to an idle state.

An outgoing call begins with activation of the Internet Telephony Program 108, which triggers the Device Interface Program 100 to enter the Wait for off hook event 205. Upon detection of a change in the USB Status and Data 441, the Device Interface Program 100 triggers the operating system to play a dial tone audio file to the active handset, and engages monitoring USB Status and Data 441 for DTMF events where a DTMF event is defined as either an actual DTMF tone or equivalent keypress data. In various embodiments, the keypress data may be created from many different input mechanisms, for example: sound recognition (which may include voice or predetermined frequency combinations), a keypad, an infrared data transmission of the number from a PDA, a touchscreen, an optically projected keypad, or a variety of bio-electronic devices including retinal motion sensors, pneumatic (breath operated) sensors, direct skin resistance sensors, or muscle motion sensors. In DTMF Detected 207 dial tone is disengaged on the first digit detection. The collection of dialed digits in DTMF Detected 207 may be terminated by use of a send key (or equivalent) or predetermined if the telephony system has a fixed length format, after which the input must be released to allow voice communication to commence, and the digits are sent in 208 to the Internet Telephony Program 108. The Device Interface Program 100 may also use a sequence of digits or other keys to trigger other events, for example, run a program, or translate to an email address or buddy name if desired or required by the Internet Telephony Program 108. After passing a called number and event to the Internet Telephony Program 108, the Device Interface Program 100 then monitors at 209 for a connection event, and plays a sound to the USB Audio 440. Detection of the connection event 210 triggers the Device Interface Program 100 to release control of USB Audio 440 to the Internet Telephony Program 108. While the call is connected, keypress data, for example: numeric entries, may be passed to the Internet Telephony program 108 for creation of DTMF tones by gateway equipment at the far end of the call where they may be used to navigate a voicemail menu, auto-attendant on a telephone system or any other DTMF activated equipment. The Device Interface Program 100 will return to Wait for off hook event 205 upon call termination as indicated by USB Status and Data 441 transitioning to on-hook status. Alternatively, the Internet Telephony Program 108 may provide all required call progress audio such as remote ring, DTMF tones and busy signals.

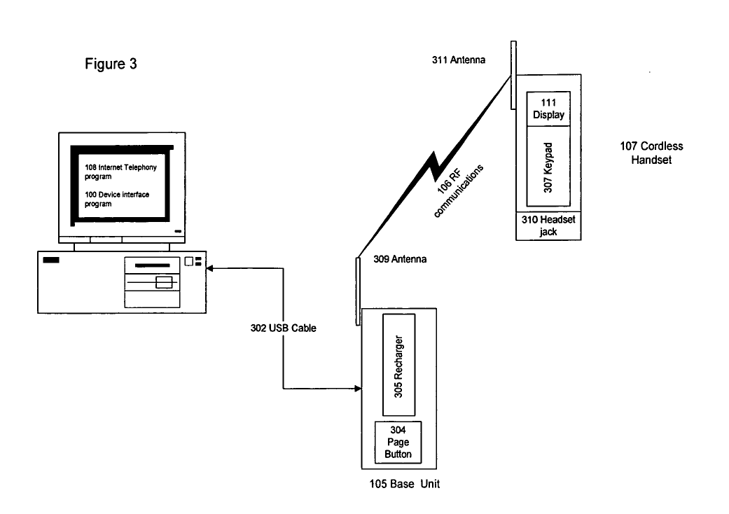

FIG. 3. Depicts a preferred embodiment where Device Interface Program 100 connects to the specialized Base Unit 105 containing recharger 305, interface electronics, and a handset page button 304, via the USB cable 302 carrying the combined USB Audio 440 and USB Status and Data 441. The Cordless handset 107 contains a Keypad 307, Headset jack 310, and Display 111 which may be used in for call progress, option selection, and remote control application prompts. The Base Unit 105 connects to the Cordless handset 107 through RF communications 106 between antennas 309 and 311.

The Base Unit 105 may optionally implement additional advanced features including, but not limited to direct access to the Display 111 from the Device Interface Program 100.

In FIG. 4, The relevant hardware is depicted in more detail. An originated Internet telephone call begins when the user presses a Talk button (or equivalent) on the Keypad 307. This sends an off hook indication via Keypad Data 418, to the HS Control Chip 416, which then signals the HS RF Module 412 via Data and Control 417 to select a clear RF channel (RF Communications 106) to the Base RF Module 411 which sends an off hook signal to the Cordless Phone Base Control Chip 406. The Cordless Phone Base Control Chip 406 formats an off hook event data packet and communicates said packet via the Serial Data Bus 402 to the USB Control Chip 400 which transmits the event to the connected Device Interface Program 100 via USB Status and Data 441. The on/off hook condition may be internally time buffered to prevent minor radio interference from causing disconnects.

The Device Interface Program 100 then commences the software actions described in FIG. 2, item 206, by playing dial tone through USB Audio 440 which is received typically as PCM (Pulse Code Modulation) data and sent via USB Control Chip 400 and Serial Data Bus 402 to the Cordless Phone Base Control Chip 406. The Cordless Phone Base Control Chip 406 interprets and formats the audio stream and forwards it to the Base RF Module 411 via Base Audio 410. The dial tone is transmitted via RF Communications 106 to the Cordless handset 107 and received in HS RF Module 412. In one embodiment, 2.4 ghz RF modules are used but this is not to preclude use of other frequencies. The HS RF Module 412 demodulates the Audio 419 (shown as two way for simplicity) which is converted to an analog signal and amplified in the HS Control Chip 416 and played via Spkr Out 431 to Speaker 430. In other embodiments Serial Data Bus 402 may be replaced with a parallel bus as required by the specific chip set selected.

The user then proceeds with the call by dialing a number on Keypad 307 which is scanned on Keypad Data 418 by HS Control Chip 416 and transmitted as Data and Control 417 through HS RF Module 412 and RF Communications 106 to Base Unit 105. The Base RF Module 411 decodes the Data and Control 409 which is formatted in Cordless Phone Base Control Chip 406 and sent to the Device Interface Program 100 via Serial Data Bus 402, USB Control Chip 400 and USB Status and Data 441.

The Device Interface Program 100 proceeds as described in FIG. 2 step 207 by collecting digits. Software adjustments for application name, number of digits, and timeouts allow the program to be tailored to the particular system in use if required. After the appropriate number of tones is collected for the selected Internet Telephony Program 108, the software proceeds as in FIG. 2. steps 208 through 210 to complete the call.

At any time, the call may be terminated by the user via the End (or equivalent) button on the keypad 307, or hanging up the Cordless handset 107 in Base Unit 105. Either action causes the HS Control Chip 416 to signal an on-hook condition to HS RF Module 412 to drop Carrier from the RF Communications 106. This results in loss of Carrier Signal in Base RF Module 411 which is communicated via Data and Control 409 to Cordless Phone Base Control Chip 406 and further to the Device Interface Program 100 via an event condition generated in Cordless Phone Base Control Chip 406 and transmitted via Serial Data Bus 402, USB Control Chip 400,and USB Status and Data 441. The Device Interface Program 100 reacts as appropriate to terminate the existing call or abort dialing.

Inbound calls commence per FIG. 2 step 201 with a software event in the Internet Telephony Program 108 which is monitored by Device Interface Program 100. The Device Interface Program 100 responds to the inbound call as described in step 202 by reading the ready status of the Base Unit 105 read via command through USB Status and Data 441, USB Control Chip 400, Serial Data Bus 402 and provided by Cordless Phone Base Control Chip 406. If Base Unit 105 and at least one Cordless handset 107 are ready to receive, the Device Interface Program 100 sends a ring command (which may activate one of a plurality of ring sounds based on incoming source information, for example, a POTS call, an Internet Call, POTS caller ID or a specific contact name) through USB Status and Data 441, USB Control Chip 400, and Serial Data Bus 402 to the Cordless Phone Base Control Chip 406. In 204 via a timer subroutine, the Device Interface Program 100 continues to monitor USB Status and Data 441 for a for a key press ( or equivalent, for example, an off-hook switch, a talk or send or “OK” button) event indicating that the user has answered the call. Upon detection of the key press, ringing ceases and the Cordless Phone Base Control Chip 406 and HS Control Chip 416 establish communication via Base Audio 410 to Base RF Module 411, RF communications 106, HS RF Module 412, and HS Audio 419 and then configure themselves to stream full duplex audio via USB Audio 440 through the USB Control Chip 400 and the Serial Data Bus 402.

Additional optional features may include a Page button 405, which manually triggers ringing of the Cordless handset(s) 107 as described above. A small display device, Display 111 may also be optionally included for display at the handset. The Battery and Charger 413 circuit is included to maintain optimal battery charge in conjunction with Battery Charger Supply Voltage 408 when Cordless handset 107 is resting in Base Unit 105. All battery charging related circuits may reside in the base, the handset, or an external charging accessory in alternative embodiments. Main Mic 420 may also be supplemented with an additional microphone and audio subtraction circuit to reduce background noise.

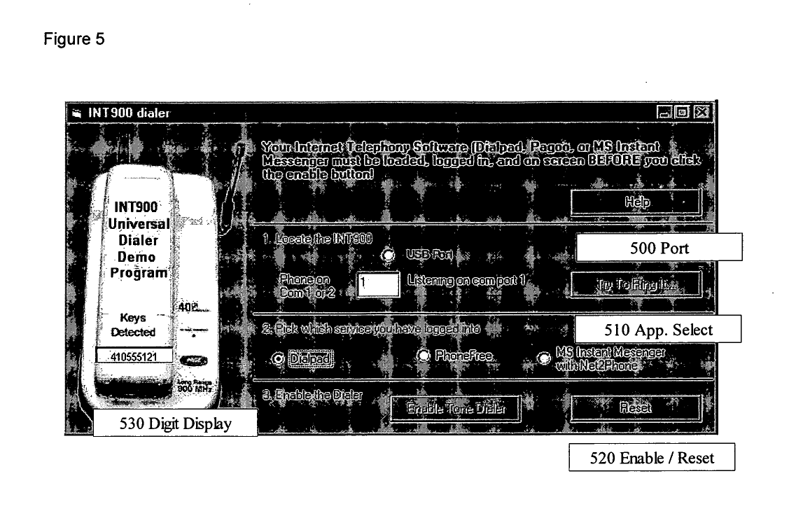

FIG. 5 depicts the graphical user window of one typical embodiment of the PC software required to interface between the invention and a Windows based PC. In Port Detection 500, the user may select a communications port, and the software will confirm presence of a device and allow a test ring to be generated, to confirm operation. The user selects an Internet Telephony Program of choice in App. Select 510, and enables dialtone and dialing with Enable/Reset 520. Detected key press data is displayed in Digit Display 530, and is automatically pasted into the selected application as pseudo-keystrokes or mouse clicks as required by that specific program. Selection of a communications port and conversion of DTMF tones to keystroke data are not required for the USB embodiment of the device as that information is received digitally through the inherent capabilities of a USB device.

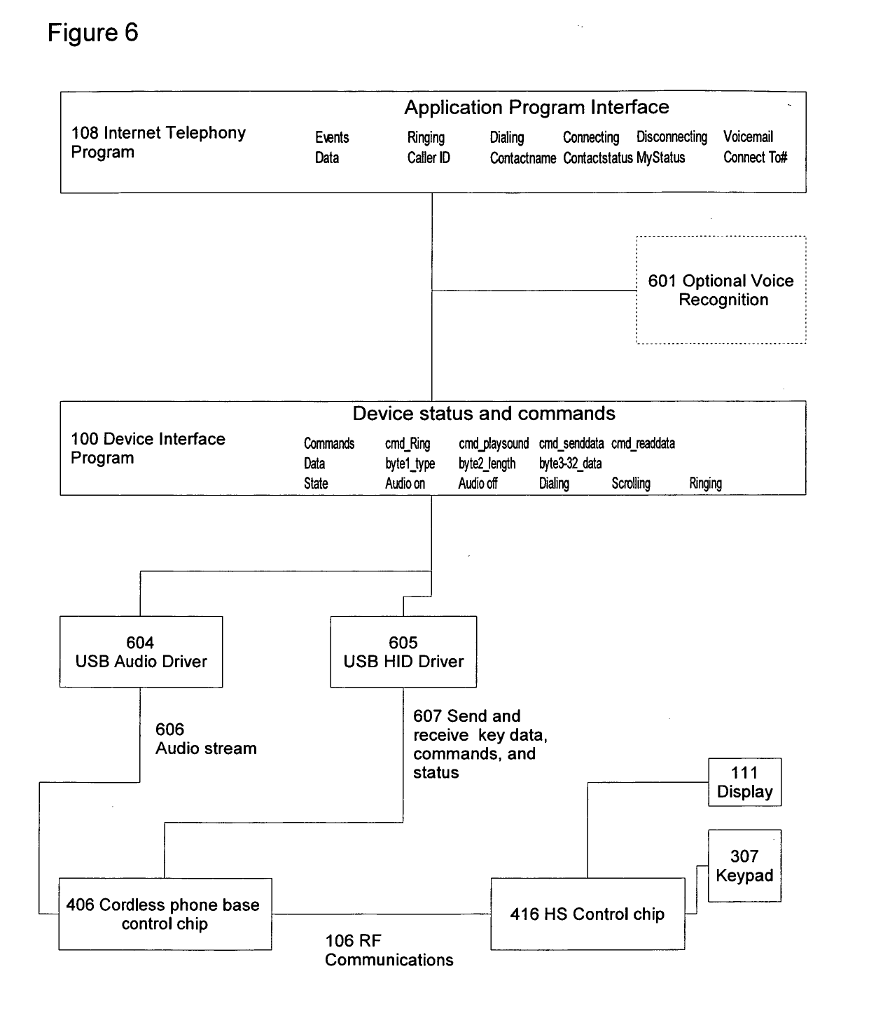

FIG. 6 depicts the typical functional flow of the required software elements inside and outside the physical device. It is recognized that other embodiments of the design may be implemented with a variety of microcontrollers and that the specific programming and functionality in the device and the USB drivers will vary accordingly. The Internet Telephony program 108 interfaces to the Device Interface Program 100 as defined by either an available API (Application Program Interface) published by the program author, or, if none is available, simply by sending key data and mouse click commands via the operating system. Generally, Internet Telephony programs will have event signals for ringing, dialing, voicemail and connecting a call as well as data request mechanisms for the inbound Caller ID information, lists of contacts or as referred to by AOL Instant Messenger, a “buddylist(tm)”, status of each defined contact or “buddy”, and the online status of the Internet Telephony Program 108. There is also a mechanism for the Device Interface Program 100 to signal the “Connect To” information as either a telephone number or contact/buddy.

The Device Interface Program 100, provides the high level control of the calling process as well as interpreting and formatting data for the operating system provided functions denoted as USB Audio Driver 604 and USB HID Driver 605. The Device Interface Program 100 maintains a state table containing, but not limited to, indications for the Dialing, Ringing, and Scrolling (user keypad menu operation) states which are combined with the Audio on/off states to also indicate an active talking status. These states are used to implement the call progress logic and administer features including, but not limited to playing dialtone when entering the dialing state and terminating the dialtone (and dialing state) when the first digit is dialed. Additionally, low level commands must be formatted and parsed for communication with the operating system drivers 604 and 605. The USB HID Driver 605 and USB Audio Driver 604 driver allow for bidirectional transfers without writing a custom operating system level device driver, but alternate implementations may use a custom or composite USB driver as well. The device specific data and events are read from the USB HID Driver 605 with a read data function that parses the input buffer to determine on-hook status, dialed digits, special function keys (like redial), keys requesting data ( menu displays), and menu selections. The send data function likewise provides variable length data, for example, a contact directory display as (multiple if required) fixed length buffer transfers. As the send data function is also used to communicate actions such as an inbound call ring command, a portion of the data may be dedicated to an operation code that either triggers an action or informs the program in the Base Control Chip 406 that the rest of the packet is data of a certain type (example: Caller ID). The play sound function instructs the USB Audio Driver 604 to start or stop streaming audio and may optionally provide a pre-recorded sound file, for example, a dial tone or busy signal. The programming in the microcontroller embedded in both Cordless Phone Base Control Chip 406 and HS Control Chip 416 is minimal, and designed simply to support the USB interface associated data transfers and commands. As the microcontroller is also operating the telephony functions, the embedded code is simply modified to divert keystroke data and status information to a USB bus, accept commands to initiate ringing, and transfer data to the display buffer in the HS Control chip 416.

Operation program flow commences on an inbound call signal from Internet Telephony Program 108. This event is detected by Device Interface Program 100, which verifies operational status by issuing a read data command to the USB HID Driver 605. The USB HID Driver 605 transfers the status block from Cordless Phone Base Control Chip 406 to Device Interface Program 100. Device Interface Program 100 then parses the data to determine that the device is currently connected, not in use, and therefore ready to receive a call. A ring command is sent by the Device Interface Program 100 to USB HID Driver 605 which transmits the packet to Cordless Phone Base Control Chip 406. Cordless Phone Base Control Chip 406 parses the packet, determines that the operation code indicates a command to initiate ringing and sends the appropriate signal to HS Control Chip(s) 416 via RF Communications 106. This entire sequence then repeats with Caller ID information instead of the Ring command, with the data then displayed on Display 111 by HS Control Chip 416. The user would then typically answer the call by a keypress on Keypad 307. The keypress is detected by HS Control Chip 416 and encoded in a signal to Cordless Phone Base Control Chip 406 via RF Communications 106. Cordless Phone Base Control Chip 406 initiates a change of state from ringing to full audio bidirectional transmission, and sets the appropriate event flag to be read by the Device Interface Program 100. The Device Interface Program 100 is scanning for status via USB HID Driver 605 and detects the event flagged by Cordless Phone Base Control Chip 406, then proceeds to notify Internet Telephony Program 108 that the call has been answered.

An outbound call sequence as previously described, begins with detection of the keypress by the HS Control Chip 416 and transmission to the Cordless Phone Base Control Chip 406. The Device Interface Program 100 detects through its regular read data command transfers that the phone is now off-hook and commences a play sound action to play a dialtone sound through USB Audio Driver 604. The Device Interface Program 100 then enters the dialing state and regularly performs read data command transfers to detect dialed digits. On the first digit, the playing of dialtone is terminated and the Device Interface Program 100 collects and transfers the digits to the Internet Telephony Program 108. When a send key is detected or a predetermine number of digits reached, the Device Interface Program 100 signals the Internet Telephony Program 108 to attempt the connection and awaits a connected event. At this time an audible ringing sound may either be played by the Device Interface Program 100 via a play sound command to the USB Audio Driver 604, or directly played by the Internet Telephony Program 108. When the Device Interface Program 100 detects a connection event from Internet Telephony Program 108, it enables full duplex audio transmission via a send data command to Cordless Phone base Control Chip 406. The call is terminated when the Device Interface Program 100 detects either a remote hangup event from the Internet Telephony Program 108 or a disconnection is detected during regular read data command scanning through the USB HID Driver 605. The previous program operation flow illustrates one possible embodiment, but it is noted that other implementations are possible and may be necessary due to the specifics of the selected hardware.

In an alternate embodiment, voice recognition could be used in place of keypress data to dial a number or select a contact. The voice recognition program could be embedded in the Cordless handset 107, Base Unit 105, or the process could be implemented as an optional component of either the Device Interface Program 100 or Internet Telephony Program 108. In voice recognition mode, the Optional Voice Recognition 601 (regardless of its location) would accept the audio stream as input, and forward keypress data or events to the upstream program, thereby emulating operation as described above.

There are functions of POTS which currently cannot be implemented in Internet Telephony, among the most important being direct access to emergency service lines in the user's locale. Therefore, it is desirable to have both POTS and Internet Telephony functions available at the user's option. However, the Cordless Internet Telephone circuitry differs significantly from a standard telephone. Instead of transmit and receive audio driving a shared 48 vdc biased telephone line (standard POTS line) through a transformer, the entire circuit is separated into separate audio transmit and receive paths. The audio signals are never coupled, except as side-tone in the physical handset, so the possibility of electronically induced echo is virtually eliminated. The ringing and on/off hook functions have also been changed to USB commands and events determined by the configurable processing capabilities of the Cordless Phone Base Control Chip 406. In an alternate embodiment, an Optional POTS Interface 442 may be provided to a POTS line with a POTS Switch mechanism to select Internet or POTS operation. The POTS interface switching could be mechanical (for example: POTS Switch 443) or implemented via software (for example: in Cordless Phone Base Control Chip 406) or a combination thereof, and would prevent recoupling the audio paths and inducing echo. Automatic switching could also be implemented based on the source of the received call as detected by Cordless Phone Base Control Chip 406.

As Internet telephony is digitized at the source, there is no transmission loss, and any echo will be amplified and retransmitted. This requires a solution that entirely separates transmit and receive. Past efforts in this field include using digital signal processors and pattern matching to subtract the audio signals, but the construction of a purely internet telephony oriented device and removing the troublesome telephony signal mix provides a simpler and more effective solution. Even advanced signal processing techniques can only approximate a clean signal, where true separation provides it inherently.

The novel device described in this application overcomes the deficiencies of telephone adapters, digital signal processors, and standard audio devices such as microphone and speaker combinations, by creation of a new hardware/software device that can emulate the capabilities of a sophisticated cordless telephone while retaining the interface compatibility and simplicity.

While a specific embodiment of the invention has been shown and described in detail to illustrate the application of the principles of the invention, it will be understood that the invention may be embodied otherwise without departing from such principles and that various modifications, alternate constructions, and equivalents will occur to those skilled in the art given the benefit of this disclosure. Thus, the invention is not limited to the specific embodiment described herein, but is defined by the appended claims.

What is claimed is:

1. A remote cordless Internet telephony device comprising:
a cordless telephone comprising a cordless telephone handset and a base unit; and a computer program having a communications path to a digital telephony network and a connection to said base unit, said computer program executing instructions designed to accept data from said base unit, transmit audio information input from said base unit to said digital telephony network, receive audio information input from said digital telephony network, convert it to a form suitable for said base unit and transmit it to said base unit; wherein said software is compatible with telephony software utilized by Internet telephony providers so as to allow emulation of a cordless POTS (Plain Old Telephone Service) telephone call over the Internet whereby one user may communicate with a second user over said digital telephony network said cordless telephone handset comprising a microphone, a speaker, means for generating dialing or keypress events, a handset rf transceiver for communication with a base unit transceiver, circuitry for translating audio information input to said microphone to an rf signal as an input to said handset rf transceiver, circuitry for translating input from said handset rf transceiver to an electrical signal as an input to said speaker, and circuitry for translating a dialing or keypress event into a DTMF tone or keystroke data as an input to said handset rf transceiver;
said base unit communicating with a computer program, and comprising a base unit rf transceiver for communication with said handset rf transceiver, means for determining whether said communication represents a DTMF signal, keystroke data or audio information, circuitry for translating communications from said handset rf transceiver into digital form for transmission to a computer program, circuitry for receiving digital data from said computer program and translating said digital data to a form suitable for transmission to said base unit rf transceiver, and a connection for transmitting data between said base unit rf transceiver and said computer program.

2. A device as in claim 1 wherein said connection comprises an RS232 serial port.

3. A device as in claim 1 wherein said connection comprises a Universal Serial Bus.

4. A device as in claim 1 wherein said connection comprises a Firewire connection.

5. A device as in claim 1 wherein said computer program is programmed to detect the presence of the remote cordless telephone on any port, and provide ready status where “ready” is defined as either (1) on hook in base or (2) out of base, not in use with radios and security codes synchronized or (3) capable of receiving or initiating a call.

6. A device as in claim 1 further comprising the functions of voicemail navigation, or selections from a telephone system auto-attendant.

7. A device as in claim 1 further comprising the functions of prompted navigation, or selections from a list of choices displayed on the handset display.

8. A device as in claim 1 further comprising at least one additional handset.

9. A device as in claim 1 wherein the base unit may communicate with one handset selected from multiple available handsets.

10. A device as in claim 1 further comprising a connection to a POTS telephone line and a switch mechanism to allow selection of either the POTS telephone function or internet telephony function.

11. A device as in claim 10 wherein the switch mechanism is a switch that is activated by pressing a key.

12. A device as in claim 10 wherein the switch mechanism is a switch is activated by removing the handset from its base or cradle.

13. A device as in claim 10 wherein the switch mechanism is operated by voice or sound.

14. A device as in claim 1 wherein the functions of the base unit are embedded in a computer which combines the functionality of the base unit and a PC.

15. A device as in claim 1 wherein the functions of the base unit are provided by the combination of a USB Key or dongle and a Device Interface Program.

16. A device as in claim 10 wherein the functions of the base unit are provided by the combination of a USB Key or dongle and a Device Interface Program.

17. A device as in claim 1 wherein the the base unit plugs directly into a USB port without a cable.

18. A device as in claim 1 wherein the the base unit plugs into a USB port with a cable

19. A device as in claim 10 wherein the the base unit plugs directly into a USB port without a cable.

20. A device as in claim 10 wherein the the base unit plugs into a USB port with a cable.

21. A device as in claim 10 wherein the communications between the handset and the embedded base unit are compliant with the DECT (Digital Enhanced Cordless Telecommunication) standard.

22. A device as in claim 1 wherein the communications between the handset and the embedded base unit are compliant with the DECT (Digital Enhanced Cordless Telecommunication) standard.

23. A device as in claim 1 wherein the means for generating a dialing or keypress event is a keypad.

24. A device as in claim 1 wherein the means for generating a dialing or keypress event is a touchscreen.

25. A device as in claim 1 wherein the means for generating a dialing or keypress event is a bioelectronic device.

26. A device as in claim 25 wherein said bioelectronic device is a retinal motion scanner.

27. A device as in claim 25 wherein said bioelectronic device is a pneumatic sensor.

28. A device as in claim 25 wherein said bioelectronic device is a direct skin resistance sensor.

29. A device as in claim 25 wherein said bioelectronic device is a muscle motion sensor.

30. A device as in claim 1 wherein the means for generating a dialing or keypress event is a voice recognition program.

31. A device as in claim 1 wherein the means for generating a dialing or keypress event is an optically projected keyboard.

32. A device as in claim 1 wherein the means for generating a dialing or keypress event is an infra-red keystroke data transmission from a Personal Digital Assistant (PDA).

33. A device as in claim 1 further comprising means for selectively blocking or diverting inbound connection from a contact on a contact list.

34. A device as in claim 1 wherein the telephony software is Skype™.

35. A device as in claim 1 wherein the telephony software is Yahoo Instant Messenger™.

36. A device as in claim 1 wherein the telephony software is MSN Instant Messenger™.

37. A device as in claim 1 wherein the telephony software is Windows Messenger™.

38. A device as in claim 1 wherein the telephony software is Voipbuster™.

39. A device as in claim 1 wherein the telephony software is Googletalk™.

40. A device as in claim 1 wherein the telephony software is AOL Phoneline™.

41. A process of establishing a Cordless Internet Telephone call, comprising:
creation of a connection to the internet under the control of an operating system further controlling an interface to a Cordless Internet Telephone, said Cordless Internet Telephone comprising a base and a cordless handset, by way of a Device Interface Program;
initiating a telephone call by a dialing process on the cordless handset which is communicated to the Device Interface Program, which indicates an outbound connection request and its destination to an Internet Telephony Program and
providing a contact list from an Internet Telephony Program and transmitting said contact list to the Cordless Internet Telephone by a Device Interface Program and associated USB drivers for RF transmission to a selected handset by a cordless handset base control device and RF transceiver and further display by a handset control device interfaced to a display unit and keypad.

42. A process as in claim 41, further comprising receiving call progress indications and feedback, similar to a POTS phone call, which are provided under the control of the Internet Telephony program and Device Interface Program.

43. A process as in claim 41 wherein the dialing process comprises entering an alphanumeric entry sequence.

44. A process as in claim 41 wherein the dialing process comprises making a selection from a contact list or menu.

45. A process as in claim 41 wherein the dialing process comprises generating a sound.

46. A process as in claim 41 wherein the dialing process comprises activating a speed dial key sequence.

47. A process as in claim 41 wherein the Device Interface Program is incorporated into the Internet Telephony Program.

48. A process for receiving a Cordless Internet Telephone call, comprising:
providing a connection to the Internet under the control of an operating system further controlling an interface to a Cordless Internet Telephone comprising a base unit and a cordless handset, by way of a Device Interface Program;
receiving an inbound connection request in an Internet Telephony Program (ITP), which said ITP forwards said request to a Device Interface Program; and determining the status of the Cordless Internet Telephone in said Device Interface Program, and returning a status indication if the handset is in use, off-line, or unavailable and sending a ring command to the cordless handset.

49. The process of claim 48 further comprising a user answering the call by activating a switch mechanism, and the Device Interface Program establishing a connection to an Internet Telephony Program.

50. A process as in claim 48 wherein the switch mechanism is activated by pressing a key.

51. A process as in claim 48 wherein the switch mechanism is a switch that detects if the handset is picked up or moved.

52. A process as in claim 48 wherein the switch mechanism is operated by voice or sound.

53. A process as in claim 48 wherein the Device Interface Program is incorporated into the Internet Telephony Program.

54. A process of establishing a connection, selectable from a connection to the internet under the control of an operating system or a connection to a POTS line, comprising
creation of a connection to the internet under the control of an operating system further controlling an interface to a Cordless Internet Telephone, said Cordless Internet Telephone comprising a base and a cordless handset, by way of a Device Interface Program and creation of a connection to a POTS line;
providing a switch mechanism having multiple selection modes for choosing between said connection to the internet and said connection to a POTS line;
selecting one of said selection modes, thereby selecting either said connection to the internet or said connection to a POTS line;
initiating a telephone call by a dialing process on the cordless handset, said dialing process comprising either communication to a Device Interface Program, which indicates an outbound connection request and its destination to an Internet Telephony Program, or connection to a POTS line, depending upon which switch position has been selected.

55. A process as in claim 54, further comprising receiving call progress indications and feedback, similar to a POTS phone call, which are provided under the control of the Internet Telephony program and Device Interface Program.

56. A process as in claim 54 wherein the dialing process comprises a numeric entry sequence.

57. A process as in claim 54 wherein the dialing process comprises making a selection from a contact list or menu.

58. A process as in claim 54 wherein the dialing process comprises generating a sound.

59. A process as in claim 54 wherein the dialing process comprises activating a speed dial key sequence.

60. A process as in claim 54 wherein the Device Interface Program is incorporated into the Internet Telephony Program.

61. A process for receiving a cordless telephone call, selectable from Internet telephony or POTS, comprising:
providing a connection to the Internet under the control of an operating system further controlling an interface to a Cordless Internet Telephone by way of a Device Interface Program;
and providing a connection to a POTS line; receiving either an inbound connection request in an Internet Telephony Program, which program forwards said request to a Device Interface Program or a ring signal from the POTS line;
in the case of an inbound connection request in an Internet Telephony Program, determining the status of the Cordless Internet Telephone in said Device Interface Program, and returning a status indication if the handset is in use, off-line, or unavailable and sending a ring command to the cordless handset;
and in the case of a ring signal from the POTS line, sending a ring command to the cordless handset.

62. The process of claim 61 further comprising a user answering the call by activating one of a plurality of switches, and the Device Interface Program establishing a connection to either an Internet Program or a POTS telephone line depending upon the source of the current inbound call.

63. A process as in claim 61 wherein the switch is activated by pressing a key.

64. A process as in claim 61 wherein the switch mechanism is a switch that detects if the handset is picked up or moved.

65. A process as in claim 61 wherein the switch mechanism is operated by voice or sound.

66. A process as in claim 61 wherein the Device Interface Program is incorporated into the Internet Telephony Program.
